(19) United States
(12) Patent Application Publication
(10) Pub. No.: US 2023/0294914 A1
(43) Pub. Date: Sep. 21, 2023

(54) WASTE-CONTAINER CONJOINING ASSEMBLY

(71) Applicant: Darrell Archie, San Jose, CA (US)

(72) Inventor: Darrell Archie, San Jose, CA (US)

(21) Appl. No.: 17/697,471

(22) Filed: Mar. 17, 2022

(51) Int. Cl. B65F 1/14

(52) U.S. Cl. CPC B65F 1/141; B65F 2220/108

(57) ABSTRACT

A waste-container conjoining assembly for facilitating moving two waste containers together includes a base. A pair of slots is positioned on a surface of the base. An edge of the base protrudes downward to define a plate. A latch is coupled to an end of the plate. The latch has an upward curvature and fasteners to the handle of a waste container. A fitting has a top with a hidden surface. The top has a pair of slots being similar to the pair of slots of the base. A back edge of the top protrudes downward to define an extension. The hidden surface of the fitting is positioned upon the surface of the base. A pair of screws and a pair of nuts secures the fitting to the base by being inserted into the pair of slots of the fitting and the base.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to bin coupling assemblies and more particularly pertains to a new bin coupling assembly for facilitating moving two waste containers together.

### Description of Related Art Including Information Disclosed Under 37 CFR 1.97 and 1.98

The prior art relates to bin coupling assemblies. The prior art includes a variety of bin coupling assemblies with a curvature to attach to another bin. Know prior art lacks a bin coupling assembly comprising a curvature for attachment to another bin and with an adjustment mechanism for fastening to the lip of the first bin.

### (H) BRIEF SUMMARY OF THE INVENTION

An embodiment of the disclosure meets the needs presented above by generally comprising a base. The base has a surface. A pair of slots is positioned on the surface. The base has an edge protruding downward from the base whereby defining a plate. The plate has an end. A latch is coupled to the end. The latch has an upward curvature relative to the end of the plate. The latch is configured for fastening to the handle of a waste container. Furthermore, the disclosure comprises a fitting. The fitting has a top. The top has a hidden surface. The top has the pair of slots similar to the base. The top has a back edge. The back edge protrudes downward relative to the top whereby defining an extension. The fitting is configured for the hidden surface of the top being positioned upon the surface of the base. Each screw of a pair of screws is configured for being inserted into a respective one of each of the slots of the base and of the top of the fitting. Each nut of a pair of nuts has a hole. The hole of each of the nuts defines a space for a screw to be positioned within. The pair of nuts is configured for securing the pair of screws within the pair of slots of the top of the fitting and the pair of slots of the base whereby retaining the fitting in a fixed positioned relative to the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is an isometric top exploded view of a waste-container conjoining assembly according to an embodiment of the disclosure.

FIG. 2 is an isometric top view of an embodiment of the disclosure.

FIG. 3 is a front view of an embodiment of the disclosure.

FIG. 4 is a side view of an embodiment of the disclosure.

FIG. 5 is a back view of an embodiment of the disclosure.

FIG. 6 is an in-use exploded view of an embodiment of the disclosure.

FIG. 7 is an in-use view of an embodiment of the disclosure.

FIG. 8 is an in-use view of an embodiment of the disclosure.

### (J) DETAILED DESCRIPTION OF THE INVENTION

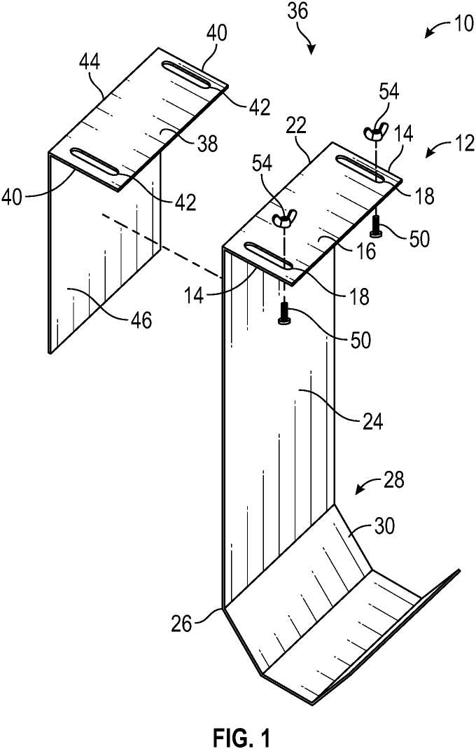

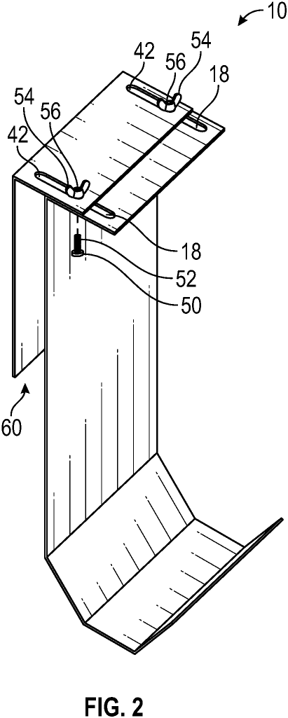

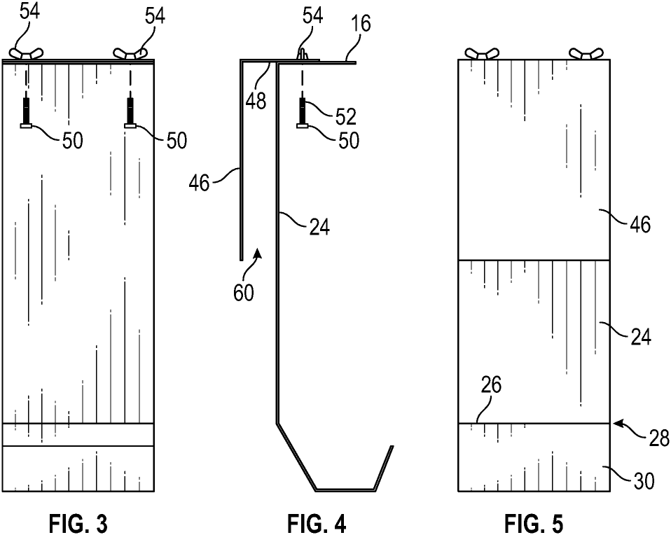

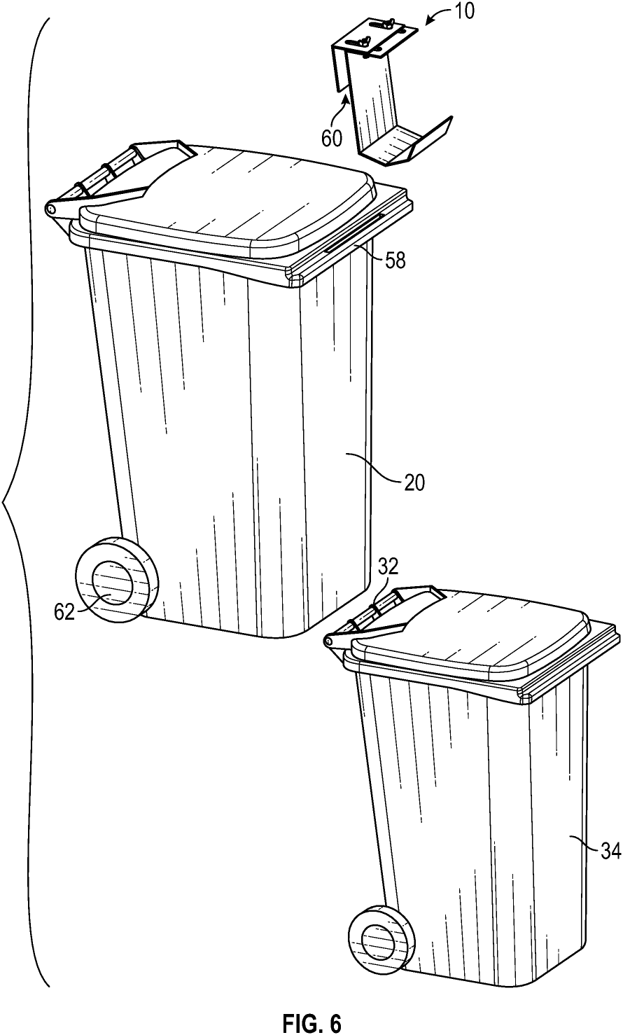

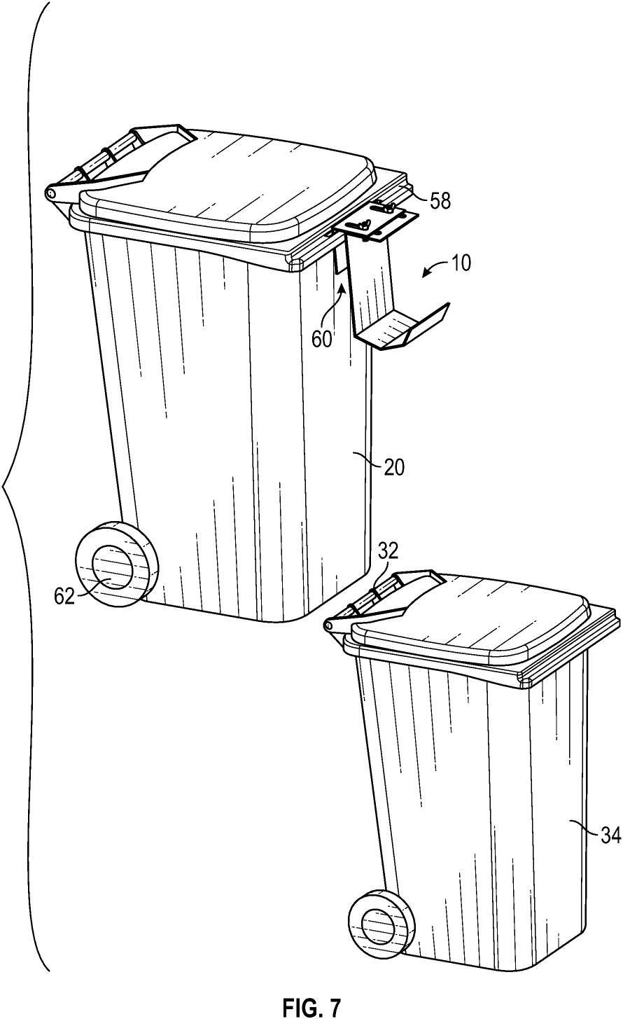

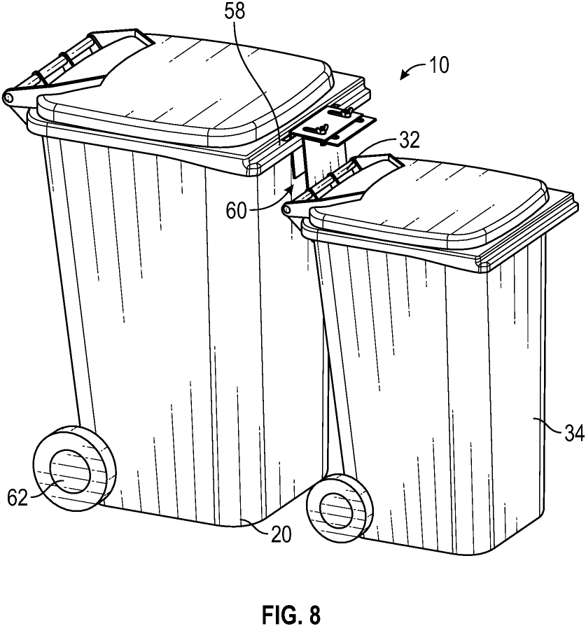

With reference now to the drawings, and in particular to FIGS. 1 through 8 thereof, a new bin coupling assembly embodying the principles and concepts of an embodiment of the disclosure and generally designated by the reference numeral 10 will be described.

As best illustrated in FIGS. 1 through 8, the waste-container conjoining assembly 10 generally comprises a base 12. The base 12 is a rectangular prism shape. The base 12 has a pair of sides 14. Each of the sides 14 is parallel to each other. The base 12 has a surface 16. A pair of slots 18 is positioned on the surface 16. Each of the slots 18 has an elongated oval shape. Each of the slots 18 is positioned proximate to a respective on of each of the sides 14 of the base 12. The pair of slots 18 of the base 12 is configured for assisting in attaching to the first bin 20.

The base 12 has an edge 22. The edge 22 is positioned perpendicular relative to the pair of sides 14. The edge 22 protrudes downward from the base 12 whereby defining a plate 24. The plate 24 is positioned perpendicular relative to the base 12. The plate 24 has an opposite edge 26. The opposite edge 26 is an end 28 of the plate 24. A latch 30 is coupled to the end 28 of the plate 24. The latch 30 protrudes upward and at an angle relative to the plate 24. The latch 30 is configured for attaching to a handle 32 of a second bin 34.

Furthermore, the waste-container conjoining assembly 10 includes a fitting 36. The fitting 36 has a top 38 being the rectangular prism shape. The top 38 has similar dimensions relative to the base 12, such as a pair of sides 40 of the top 38 is similar to the dimensions of the pair of sides 14 of the base 12. The top 38 has a pair of slots 42 similar to the pair of slots 18 of the base 12. The pair of slots 42 of the top 38 is configured for being positioned upon the pair of slots 18 of the base 12. The top 38 has a back edge 44. The back edge 44 protrudes downward relative to the top 38 whereby defining an extension 46. The extension 46 is positioned perpendicular relative to the top 38 of the fitting 36. The top 38 has a hidden surface 48. The hidden surface 48 of the top 38 is configured for be positioned upon the surface 16 of the base 12.

Each screw 50 of a pair of screws 50 has an outer surface 52. The outer surface 52 of each of the screws 50 has threading. Each of the screws 50 is configured for being inserted into a respective one of each of the slots 18 of the base 12 and each of the slots 42 of the top 38 of the fitting 36 when the fitting 36 is positioned upon the base 12. Each nut 54 of a pair of nuts 54 has a hole 56. Each of the nuts 54 is a wing nut, and the hole 56 of each of the nuts 54 defines a space for a screw to be positioned within. The hole 56 of each of the nuts 54 has threading, whereby the hole 56 of each of the nuts 54 is complementary to the outer surface 52 of each of the screws 50. Each of the nuts 54 is configured for engaging by threading with each of the screws 50.

The pair of nuts 54 is configured for securing the pair of screws 50 within the pair of slots 42 of the top 38 of the fitting 36 and the pair of slots 18 of the base 12 whereby retaining the fitting 36 in a fixed position upon the base 12. The plate 24 of the base 12 and the extension 46 of the fitting 36 are configured for facing the same direction. A gap 60 between the extension 46 of the fitting 36 and the plate 24 of the base 12 defines a space for the waste-container conjoining assembly 10 to be positioned on a lip 58 of the first bin 20.

In use, the user positions the gap 60 between the extension 46 and the plate 24 onto the lip 58 of the first bin 20. The user can adjust the area of the gap 60 by adjusting the pair of screws 50 and the pair of nuts 54 within the pair of slots 42 of the fitting 36 and the pair of slots 18 of the base 12. When the fitting 36 and the base 12 are secured on the lip 58 of the first bin 20, the latch 30 of the base 12 can be attached to the handle 32 of the second bin 34. The latch 30 is positioned on the underside of the handle 32, and the user tilts the first bin 20 backwards at an angle whereby hoisting the second bin 34 upon the latch 30 of the base 12. The first bin 20 can cart around the second bin 34 by using the wheels 62 of the first bin 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A waste-container conjoining assembly comprising:
a base, said base having a surface, a pair of slots being positioned on said surface, said base having an edge, said edge protruding downward from said base whereby defining a plate, said plate having an end, a latch being coupled to said end, said latch having an upward curvature relative to said end of said plate, said latch being configured for fastening to the handle of a waste container said latch and said surface both extending from said plate in a same direction wherein said surface is positioned spaced above said latch;
a fitting, said fitting having a top, said top having a hidden surface, said top having a pair of slots, said pair of slots of said top being similar to said pair of slots of said base, said top having an back edge, said back edge of said top protruding downward relative to said top whereby defining an extension, said fitting being configured for said hidden surface of said top being positioned upon said surface of said base, said extension and said plate facing the same direction;
a pair of screws, each of said screws being configured for being inserted into a respective one of each of said slots of said base and of said top of said fitting; and
a pair of nuts, each of said nuts having a hole, said hole of each of said nuts defining a space for a screw to be positioned within, said pair of nuts being configured for securing said pair of screws within said pair of slots of said top of said fitting and said pair of slots of said base whereby retaining said fitting in a fixed position relative to said base.

2. The waste-container conjoining assembly of claim 1, further comprising said base being a rectangular prism shape.

3. The waste-container conjoining assembly of claim 2, further comprising said base having a pair of sides, each of said sides being parallel to each other.

4. The waste-container conjoining assembly of claim 1, further comprising each of said slots having an elongated oval shape.

5. The waste-container conjoining assembly of claim 3, further comprising each of said slots being positioned adjacent to a respective one of each of said sides.

6. The waste-container conjoining assembly of claim 3, further comprising said edge being positioned perpendicular relative to each of said sides.

7. The waste-container conjoining assembly of claim 1, further comprising said plate being positioned perpendicular relative to said base.

8. The waste-container conjoining assembly of claim 1, further comprising said end being an opposite edge of said plate, said end being parallel to said edge of said base.

9. The waste-container conjoining assembly of claim 2, further comprising said top being said rectangular prism shape, said top having similar dimensions relative to said base.

10. The waste-container conjoining assembly of claim 1, further comprising said pair of slots of said top being configured for being positioned upon said pair of slots of said surface of said base.

11. The waste-container conjoining assembly of claim 1, further comprising said extension being positioned perpendicular relative to said top.

12. The waste-container conjoining assembly of claim 1, further comprising each of said screws having an outer surface, said outer surface of each of said screws having threading.

13. The waste-container conjoining assembly of claim 1, further comprising each of said nuts being a wing nut.

14. The waste-container conjoining assembly of claim 12, further comprising said hole of each of said nuts having threading, said hole of each of said nuts being complementary to said outer surface of each of said screws.

15. The waste-container conjoining assembly of claim 14, further comprising each of said nuts being configured for engaging by threading with each of said screws.

16. A waste-container conjoining assembly comprising:
a base, said base being a rectangular prism shape, said base having a pair of sides, each of said sides being parallel to each other, said base having a surface, a pair of slots being positioned on said surface, each of said slots having an elongated oval shape, each of said slots being positioned adjacent to a respective one of each of said sides, said base having an edge, said edge being positioned perpendicular relative to each of said sides, said edge protruding downward from said base whereby defining a plate, said plate being positioned perpendicular relative to said base, said plate having an end, said end being an opposite edge of said plate, said end being parallel to said edge of said base, a latch being coupled to said end, said latch having an upward curvature relative to said end of said plate, said latch being configured for fastening to the handle of a waste container, said latch and said surface both extending from said plate in a same direction wherein said surface is positioned spaced above said latch;
a fitting, said fitting having a top, said top being said rectangular prism shape, said top having similar dimensions relative to said base, said top having a hidden surface, said pair of slots of said top being similar to said pair of slots of said base, said pair of slots of said top being configured for being positioned upon said pair of slots of said surface of said base, said top having an back edge, said back edge of said top protruding downward relative to said top whereby defining an extension, said extension being positioned perpendicular relative to said top, said fitting being configured for said hidden surface of said top being positioned upon said surface of said base, said extension and said plate facing the same direction;
a pair of screws, each of said screws having an outer surface, said outer surface of each of said screws having threading, each of said screws being configured for being inserted into a respective one of each of said slots of said base and of said top of said fitting; and
a pair of nuts, each of said nuts being a wing nut, each of said nuts having a hole, said hole of each of said nuts defining a space for a screw to be positioned within, said hole of each of said nuts having threading, said hole of each of said nuts being complementary to said outer surface of each of said screws, each of said nuts being configured for engaging by threading with each of said screws, said pair of nuts being configured for securing said pair of screws within said pair of slots of said top of said fitting and said pair of slots of said base whereby retaining said fitting in a fixed position relative to said base.
